(19) United States
(12) Patent Application Publication
(10) Pub. No.: US 2007/0004473 A1
(43) Pub. Date: Jan. 4, 2007

(54) Wireless softphone headset system with incoming call alert and headset hookswitch control

(75) Inventors: Mark C. Clark, Aptos, CA (US); Will Morrell, Santa Cruz, CA (US); Steve C. Evans, Aptos, CA (US); Ilia V. Langouev, Santa Cruz, CA (US)

Correspondence Address: PLANTRONICS, INC., 345 ENCINAL STREET, P.O. BOX 635, SANTA CRUZ, CA, 95060-0635, US

(73) Assignee: Plantronics, Inc., Santa Cruz, CA (US)

(21) Appl. No.: 11/173,362

(22) Filed: Jul. 1, 2005

(51) Int. Cl. H04M 1/00

(52) U.S. Cl. 455/575.2

(57) ABSTRACT

Systems and methods for wireless audio headsets for use with communication applications such as softphone applications running on processor-based hosts for alerting a user of incoming calls and providing hookswitch control from the wireless headset are disclosed. The system generally includes a headset base for communication with a processor-based host executing a communication-headset application for interfacing between a network and the wireless headset system, and a wireless headset in wireless communication with the headset base. The wireless headset system may be configured to cooperate with the communication-headset application to answer an incoming call in response to a call answering activity and, upon the incoming call being answered, to transmit audio signals between the network and the wireless headset via the communication-headset application and the headset base.

### BACKGROUND OF THE INVENTION

1. Field of the Invention

The present invention relates generally to wireless headsets for use with softphone applications running on personal computers or other processor-based hosts. More specifically, wireless audio headset systems and methods for use with mediated communication applications such as softphone applications running on processor-based hosts for alerting a wireless headset user of incoming communication calls and providing hookswitch control from the wireless headset are disclosed.

2. Description of Related Art

Audio headsets such as communication headsets are used in numerous applications. Communication headsets are particularly effective for telephone operators, customer service agents such as in call centers, radio operators, aircraft personnel, and/or any user who frequently use telephones or computer telephony applications and/or for whom it is desirable to have hands free operation of communication systems. Accordingly, a wide variety of communication headsets are available. For example, communication headsets may be adapted for use with corded and cordless conventional telephones, soft phones, cellular or mobile telephones, and the like.

The headset is typically in communication with a base unit, e.g., a base telephone, a computer (or other processor-based host), or a headset base which may in turn be in communication with the computer. The headset may be wired or wireless. A wireless headset provides added convenience and operability that is free of wires or cables. A wired headset may be connected to the base unit via a connector such as a Quick Disconnect™ (QD) connector so as to provide added convenience and operability. The QD connector may be a mechanical interconnect positioned between the headset and the base unit or between the headset and a telephone headset adapter connected to the base unit. The user may simply and quickly disconnect the headset at the QD connector rather than at the base unit so that the headset user does need not to remove the headset and, instead, can keep the headset on even when the user moves away from the base unit.

### SUMMARY OF THE INVENTION

Wireless audio headset systems and methods for use with mediated communication applications such as softphone applications running on processor-based hosts for alerting a wireless headset user of incoming communication calls and providing hookswitch control from the wireless headset are disclosed. It should be appreciated that the present invention can be implemented in numerous ways, including as a process, an apparatus, a system, a device, or a method. Several inventive embodiments of the present invention are described below.

The system generally includes a headset base for communication with a processor-based host executing a host mediated communications-headset application for interfacing between a network and the wireless headset system, and a wireless headset in wireless communication with the headset base. The wireless headset system may be configured to cooperate with the host mediated communications-headset application to answer an incoming call in response to a user call answering activity and, upon the incoming call being answered, to transmit audio signals between the network and the wireless headset via the host mediated communications-headset application and the headset base. The user call answering activity may be activation of a talk switch on the headset and/or removal of the wireless headset from the headset base. The host mediated communications-headset application may include a host mediated communications application and a host mediated communications-headset integrator application for interfacing between the softphone application and the headset base.

The headset base may enter an incoming alert mode in response to receiving an incoming call message generated by the host mediated communications-headset application upon arrival of an incoming communication call. When in the incoming call alert mode, the headset system may emit audio sounds and/or light at the wireless headset and/or the headset base. Once the user performs the user call answering activity, the headset system may establish an audio link over a wireless connection between the headset base and the wireless headset. A link established or other acknowledgement message may then be transmitted by the headset base to cause the host mediated communications-headset application to answer the incoming call. The wireless headset system may also cooperate with the host mediated communications-headset application to terminate a communication call upon activation of the talk switch and/or upon returning the wireless headset to the headset base.

Each of the headset base and the wireless headset may implement Digital Enhanced Cordless Telecommunications (DECT) compliant technology via DECT controllers in the headset base and the headset to facilitate communication therebetween. The headset base may also be configured to communicate with the hose via a host universal serial bus (USB) port. In addition, the host mediated communications-headset application may be a Voice over Internet Protocol (VoIP) softphone-headset application.

A method employing a wireless audio headset cooperating with a host mediated communications-headset application running on a processor-based host generally includes transmitting an incoming call message upon receiving an incoming communication call on a network by the host mediated communications-headset application to a headset base of a wireless headset system, entering an incoming call alert mode by the wireless headset system by emitting audio sounds and/or light at a wireless headset and/or the headset base, in response to a user call answering activity, answering the incoming call by the host mediated communications-headset application cooperating with the wireless headset system including establishing an audio link between the headset base and the wireless headset, and upon the incoming call being answered, transmitting audio signals between the network and the wireless headset via the host mediated communications-headset application and the headset base.

The answering the incoming call may further include terminating the incoming call alert mode, transmitting a link established message to the host mediated communications-headset application, and answering the incoming call by the host mediated communications-headset application to connect audio between the wireless headset and the network.

The method may further include, in response to a user call terminating activity, terminating a communication call by the host mediated communications-headset application cooperating with the wireless headset system. The user call terminating activity may be activation of the talk switch on the wireless headset and/or replacement of the wireless headset to the headset base. Terminating the communication call may include releasing the audio link between the headset base and the wireless headset, transmitting a call termination message from the headset base to the application, and terminating the communication call by the application in response to the call termination message. When the user terminates the call by activating the talk switch, terminating the communication call may further include transmitting a key code corresponding to the talk switch from the wireless headset to the headset base via the audio link where the transmitting the call termination message is performed upon receiving the key code corresponding to the talk switch at the headset base and the releasing the audio link is performed after terminating the communication call. Alternatively, if the user terminates the call by replacing the wireless headset to the headset base, releasing the audio link may be performed prior to the transmitting the call termination message and terminating the communication call.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is a block diagram illustrating an exemplary embodiment of a system in which a wireless headset system is in communication with a processor-based host.

FIG. 2 is a block diagram illustrating the system of FIG. 1 in more detail.

FIG. 3 is a flow chart illustrating an exemplary process for alerting the wireless headset user of an incoming call via the wireless headset.

FIG. 4 is a flow chart illustrating an exemplary process for providing the wireless headset user with on-hook hookswitch control via the wireless headset.

FIG. 5 is a flow chart illustrating an exemplary process for providing the wireless headset user with off-hook hookswitch control via the wireless headset.

FIG. 6 illustrates an example of a computer system that can be utilized with the various embodiments of method and processing described herein; and

FIG. 7 illustrates a system block diagram of the computer system of FIG. 6.

### DESCRIPTION OF SPECIFIC EMBODIMENTS

Wireless audio headset systems and methods for use with mediated communication applications such as softphone applications running on processor-based hosts for alerting a wireless headset user of incoming communication calls and providing hookswitch control from the wireless headset are disclosed. It is noted that communications calls as referred to herein include not only telephone calls but various other communication calls including, for example, intercom, Internet chat, and the like. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

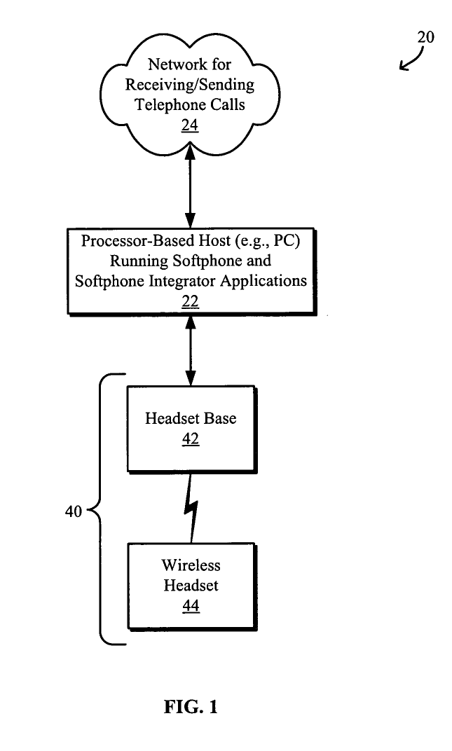

FIG. 1 is a block diagram illustrating an exemplary embodiment of a processor-based host and wireless headset system 20, e.g., a digital wireless softphone VOIP headset system in which a wireless headset apparatus or system 40 is in communication with a processor-based host 22 executing a softphone application. The digital wireless headset system 20 may implement DECT (Digital Enhanced Cordless Telecommunications) compliant technology, a European cordless phone standard, or any other suitable protocol and/or standard. It is noted that although in the examples presented herein, the wireless headset system 20 is implemented and/or utilized with a softphone software application, the wireless headset system 20 may be similarly implemented and/or utilized with various other host mediated network communication applications such as intercom, Internet chat, Internet telephony, voice over data such as VoIP softphone, and the like.

As shown, the wireless headset system 40 generally includes a headset base 42 and a wireless headset 44. The wireless headset 44 is in wireless communication, e.g., using radio frequency (RF) technology, with the headset base 42. The headset base 42 is in turn in communication with the host device 22 such as via a connection to a Universal Serial Bus (USB) port provided on the host device 104 or any other suitable communication port or mechanism. For example, although a wired connection is typically employed between the headset base 42 and the host 22, wireless connections may alternatively be employed. Thus, the term “connection” utilized herein generally refers to both wired and wireless connections. In addition, the wireless headset 44 and/or the headset base 42 may be selectively powered on or off and thus be selectively in communication with each other and/or with the host 22.

The processor-based host 22 may be in communication with one or more networks 24 for receiving incoming and sending outgoing communication calls. The network 24 may be for example, the Internet, an intranet network, or a LAN (local area networks). Although not shown, the network 24 may be in communication with other networks including, for example, a public switched telephone network (PSTN) or a Private Branch Exchange (PBX) for completing a communication call on a remote end to a remote call recipient or remote caller. The processor-based host 22 generally can be any suitable processor-based device such as a personal computer (PC), a personal digital assistant (PDA), a digital music player (e.g., MP3 player), a video player (e.g., DVD player), a video game player, and a processor-based telephone. Although shown as separate components, the host 22 and the headset base 42 may be integrated as a single component.

The processor-based host and wireless headset system 20 may be implemented with voice over Internet Protocol (VoIP) technology for receiving incoming and making outgoing communication calls via the network 24. In particular, the host 22 may execute software applications such as a VoIP telephony software application 28 and a wireless headset softphone-headset integrator application 30 to facilitate the receiving of incoming and the placing of outgoing communication calls using the wireless headset 44 via the headset base 42. Specifically, the VoIP telephony software application 28 facilitates communication with the network 24 for receiving and placing communication calls and interfaces with the softphone-headset integrator application for facilitating transfer of audio signals between the headset system 40 and the host 22. Although the softphone application 28 and the softphone-headset integrator application 30 are described separately herein, it is to be understood that the functions of softphone-headset integrator application may be integrated into a single softphone headset integrated application, for example.

The headset base 42 not only facilitates communication between the wireless headset 44 and the host 22 but may optionally also serve as a cradle to facilitate storage of the wireless headset 44 and recharging of a rechargeable battery contained in the wireless headset 44. It is noted that a docking and/or charging portion or component of the headset base 42 may be physically integrated with the headset base 42 or may be a physically separate component from the remainder of the headset base 42. The headset base 42 may be powered via the USB connection but can be alternatively or additionally be powered via an external power source such as via an alternating current (AC) adapter. The external power source may facilitate the recharging of the wireless headset 22 when the host 22 is powered down, for example, and/or may supplement the power provided via the USB connection.

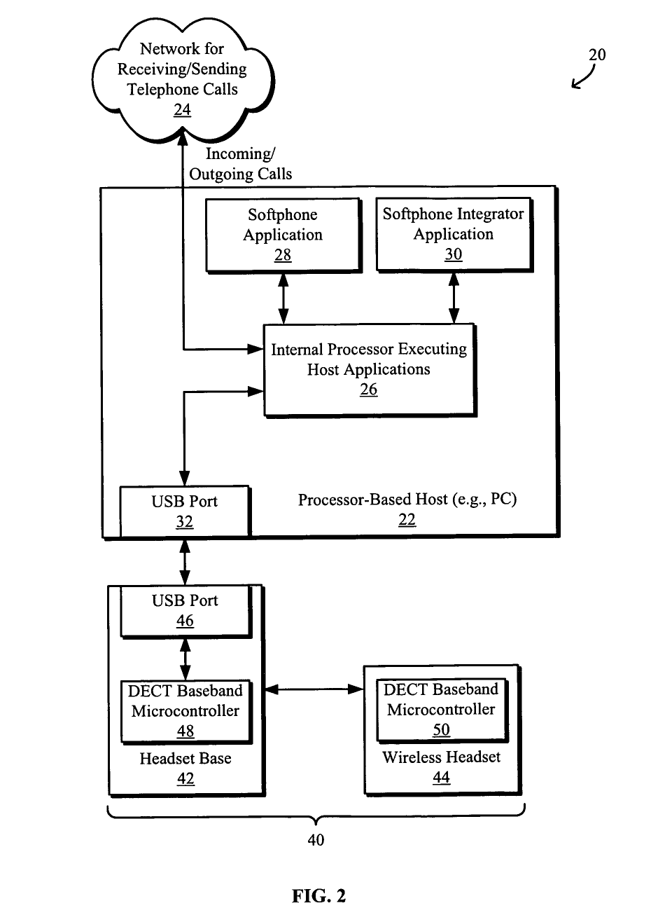

FIG. 2 is a block diagram illustrating the processor-based host and wireless headset system 20 in more detail. As shown, the host 22 includes an internal processor 26 such as a CPU that controls hardware and application software on the host. For example, the internal processor 26 may execute software applications such as the softphone application 28 and the softphone-headset integrator application 30. The term softphone application generally refers to a telephony application running on a PC or other processor-based host.

The headset base may include a base communication port through which to communicate with a corresponding communication port of the host 22. For example, the base port may be a base USB port 46 corresponding to a host USB port 32.

The headset base 42 may further include a base DECT baseband microcontroller 48 to implement DECT compliant technology. A headset DECT baseband microcontroller 50 may also be provided in the wireless headset 44 to communicate with the base DECT controller 48. It is to be understood that while the headset system 40 is described herein to implement the DECT compliant technology, other technologies, protocols and/or standards may be similarly implemented.

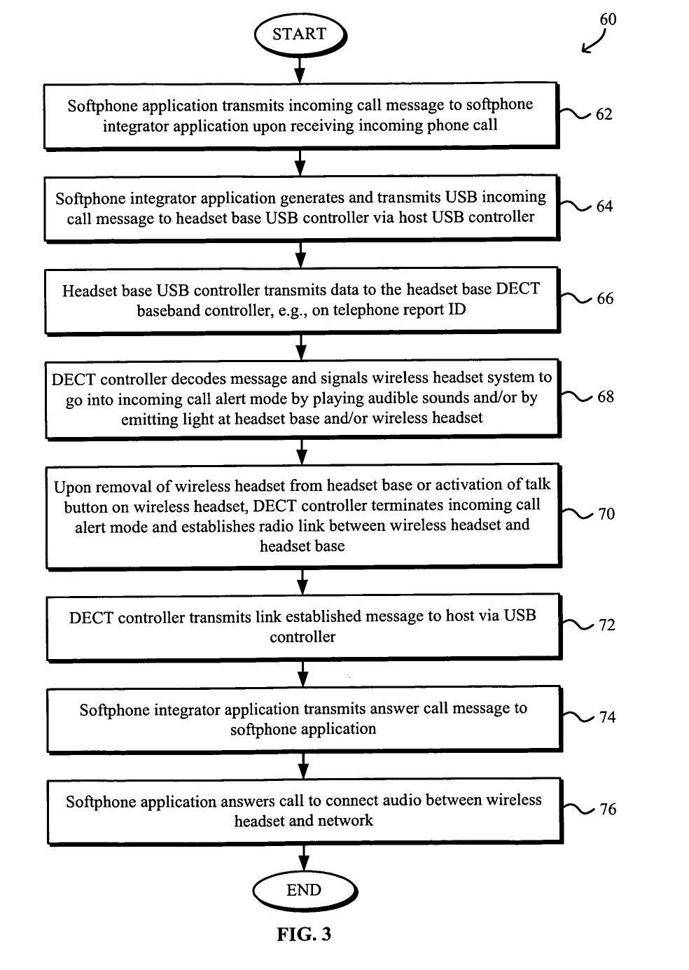

FIG. 3 is a flow chart illustrating an exemplary process 60 for an incoming call alert and answering process 60. Specifically, process 60 alerts the wireless headset user of an incoming call and connects the incoming call via the wireless headset system upon the user answering the call. In particular, when an incoming communication call is received by the softphone application, the softphone application generates and transmits an incoming call message to the softphone-headset integrator application at block 62. As noted, functions of the softphone-headset integrator application 30 may be integrated into a single softphone headset integrated application so that block 62 need not be performed.

At block 64, the softphone-headset integrator application generates and transmits a USB incoming call message to the headset base USB controller via the host USB controller. As is well known, USB allows two-way communication between peripheral devices and a processor-based host. When the USB headset base unit is initially connected to the host, the host (or a hub) detects the USB headset base unit and performs an enumeration process that may assign an identifier to the device and inform the host computer of the capabilities of the USB headset base unit (e.g., input, output, etc). The USB headset base unit typically also informs the host of its identification information, such as the vendor, product, version, serial number, and/or the like.

As with the examples described herein, the headset system may be a Human Interface Device (HID). HID is a class of USB devices such as a mouse, joystick, keyboard, and the like that gives structure to the data transferred between the device and the host using a generic HID driver supplied by the host's operating system so that the host can interpret the data received from the USB device without a separate device driver specially designed for the particular HID. As an HID, the headset base unit may, during the USB enumeration process, identify itself as an HID, describe the information that it can receive and send, and describe how the data should be interpreted to the host, e.g., via the HID descriptor. Although the headset system is described as an HID in the examples presented herein, the headset system need not be an HID and a separate device driver may be supplied to facilitate communication between the host and the non-HID headset system. Furthermore, although the headset system is described as being in communication with the host via USB ports, various other suitable communications ports may be similarly utilized.

With the USB headset system as an HID, in generating the USB incoming call message for transmission to the headset USB controller, the softphone-headset integrator application may map the USB incoming call message to a telephony page HID button (e.g., bit) in the HID descriptor for the headset system (or the headset base). As is known, the HID descriptor gives the host operating system knowledge of each control for the headset system.

When the USB controller receives the incoming call message from the host, the headset base USB controller transmits data in the incoming call message to the headset base DECT baseband controller on the telephony report ID at block 66. Communication between the headset base USB and DECT microcontrollers may be via an Intelligent Interface Controller (12C) bus shared therebetween. It is noted that the functions of the USB and DECT microcontrollers may also be provided in a single device.

At block 68, the headset base DECT controller decodes the incoming call message and causes the headset system to go into incoming call alert mode. In particular, if the wireless headset is docked in the headset base, the headset base may emit audible sounds, e.g., by playing a melody via a piezoelectric transducer located on the headset base, and/or may emit light, e.g., by blinking a light emitting diode (LED) provided on the wireless headset. When the headset base is emitting audible sounds and/or emitting light, the headset base may simulate the cadence of a ringing telephone, for example. If the wireless headset is not docked in the headset base, e.g., when the wireless headset is worn by the user, the headset base DECT controller, using the standard DECT protocol, signals the wireless headset to emit audible sounds via the wireless headset earpiece, e.g., by playing a ring melody in the earpiece. It is noted that the audible alert by the wireless headset may be emitted from the earpiece and/or from any other speaker equipped on the wireless headset. In one embodiment, the volume of the audible alert can be sufficiently loud to alert the user when the wireless headset is not docked and is also not donned on the user.

The user may answer the incoming call is by performing a call answering activity with and/or on the wireless headset. For example, while the wireless headset is undocked or otherwise removed from the headset base, such as when the user is wearing the wireless headset, examples of call answering activities may include activating or depressing a talk switch (e.g., button or key) on the wireless headset, providing a voice command at the wireless headset, having an autodial a voice command portal feature activated, having an auto answer feature activated (e.g., set to answer after 1 ring), having an answer-to-voicemail feature activated (to have the call be answered by voicemail), etc. Alternatively, when the wireless headset is docked in/on the headset base, the call answering activity may include removing the wireless headset from the storage and/or charging cradle of the headset base. Upon performing the call answering activity, e.g., removal of wireless headset from headset base or activation of talk button on wireless headset, the DECT controller terminates the incoming call alert mode and establishes an audio link over the wireless connection between the wireless headset and the headset base at block 70. Note that where the headset is removed from the headset base, a short delay, e.g., approximately 1.5 to 2 seconds, in the call answering process, such as the establishing of the audio link between the base and the headset, may be introduced between when the wireless headset is removed from the charging cradle and when the call is connected to provide time for the user to don the headset. Various other methods for introducing the delay may be similarly implemented.

At block 72, the headset base DECT transmits a link established message to the softphone-headset integrator application running on the host via the headset and host USB controllers. Specifically, the headset base USB controller may transmit data contained in the link established message to the host computer, e.g., as an HID input report on the telephony report ID via the host USB controller. At block 74, the softphone-headset integrator application transmits an answer call message to the softphone application running on the host. At block 76, the softphone application answers the call (off-hook) in response to the answer call message to connect audio between the wireless headset system and the network. The wireless headset user can thus communicate with the remote calling party.

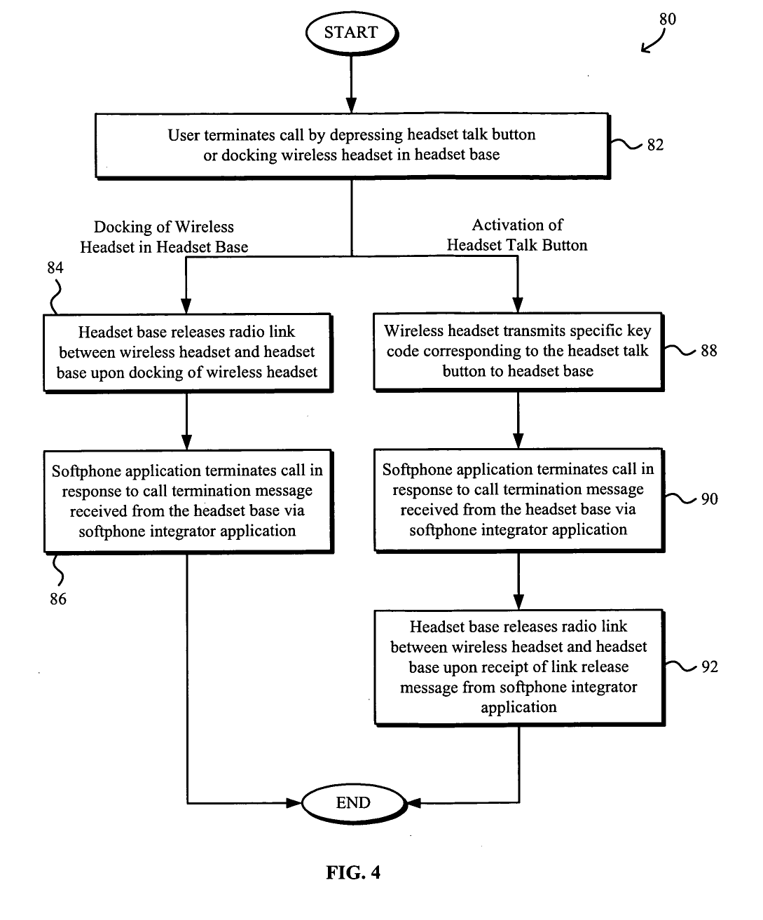

The headset system in conjunction with the softphone-headset integrator and softphone applications may provide on-hook hookswitch control via the wireless headset to allow the user to terminate an incoming or outgoing communication call. An exemplary process 80 for providing the wireless headset user with on-hook hookswitch control via the wireless headset is illustrated in the flowchart of FIG. 4. In particular, at block 82, the user may terminate an incoming or outgoing communication call by performing a call terminating activity with and/or on the wireless headset. Examples of call terminating activities may include activating or depressing the talk switch (e.g., button or key) on the wireless headset, providing a voice command at the wireless headset, docking the wireless headset on/in the headset base, e.g., the storage and/or charging cradle provided by the base.

If the call is being terminated by docking the headset, the headset base releases the audio link between the base and the headset upon docking of the headset in the base at block 84. Once the audio link release is complete, the softphone application terminates the incoming or outgoing call in response to messaging from the headset base via the softphone-headset integrator application and the USB controllers at block 86. In particular, the DECT controller sends a call termination message to the headset base USB controller which in turn sends the data in the call termination message to the host PC as an HID input report on the telephony report ID via the host USB controller. Upon receiving the HID input report from the headset system, the soft phone integrator application transmits a terminate call message to the softphone application to terminate the call (on-hook).

Alternatively, if the user presses the talk key or button to terminate the incoming or outgoing call, a message conveying a key code corresponding to the talk key is transmitted from the wireless headset to the headset base at block 88. The message conveying the key code may be, for example, part of a proprietary data packet known as an Escape To Proprietary (ETP) in DECT protocol or, as another example, a standard DECT key press message. At block 90, the softphone application terminates the incoming or outgoing call in response to messaging from the headset base via the softphone-headset integrator application and the USB controllers. In particular, when the headset base receives the ETP message containing the key code, the headset base decodes the ETP message and the DECT controller transmits a call termination message to the headset base USB controller which in turn sends the data in the call termination message to the host as an HID input report on the telephony report ID to the soft phone integrator application. The soft phone integrator application then sends a terminate call message to the softphone application to terminate the call (on-hook). At block 92, the soft phone integrator application may also transmit a release audio link message to the headset base to release the audio link, for example, in order to maximize battery life of the headset between calls.

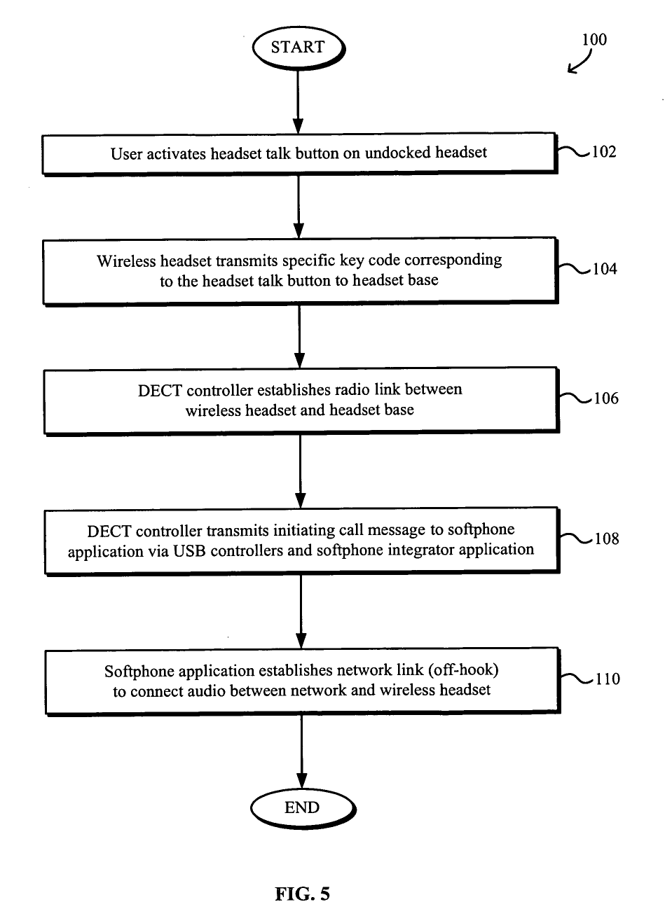

The headset system in conjunction with the softphone-headset integrator and softphone applications may further provide hookswitch control by enabling the user to cause the headset and softphone application system to go off-hook, e.g., to allow the user to initiate an outgoing call, by removing the wireless headset from the headset base and activating, e.g., depressing, a talk button or key on the wireless headset. An exemplary process 100 for providing the wireless headset user with off-hook hookswitch control via the wireless headset is illustrated in the flowchart of FIG. 5. At block 102, the user activates the headset talk button on the undocked headset. At block 104, the wireless headset transmits a key code corresponding to the talk key from the wireless headset to the headset base. As noted above, the key code message may be part of a proprietary data packet known as an ETP in DECT protocol or may be a standard DECT key press message. The DECT controller establishes an audio link between wireless headset and headset base at block 106 and transmits an initiating call message to the softphone application executing on the host via headset base and host USB controllers and the softphone-headset integrator application at block 108. At block 110, the softphone application establishes a network link (off-hook) to connect audio between the network and the wireless headset.

As is evident, the call answering and hookswitch control processes 60, 80, 100 described above with reference to FIGS. 3-5 simulate the typical and well established corresponding processes employed by the user using a traditional phone and/or a traditional headset, wired or wireless (or cordless). In particular, the user typically picks up a handset or headset from a storage location to initiate or answer a call and typically replaces the handset or headset in the storage location to end the call. It is noted that the call answering and hookswitch control processes 60, 80, 100 described above with reference to FIGS. 3-5 are merely illustrative implementations and various modifications, including changing the order of the individual blocks of the processes, may be implemented. In addition, various other call features may be similarly implemented. For example, the wireless headset system may be configured to implement a call waiting feature in which the user may choose to alternately connect to a second call by performing a call answer activity (e.g., depress the talk switch) while a first communications call is still active. Merely as examples of other call features, the wireless headset system may also be configured to implement a hold feature, conference feature, call transfer feature, and the like.

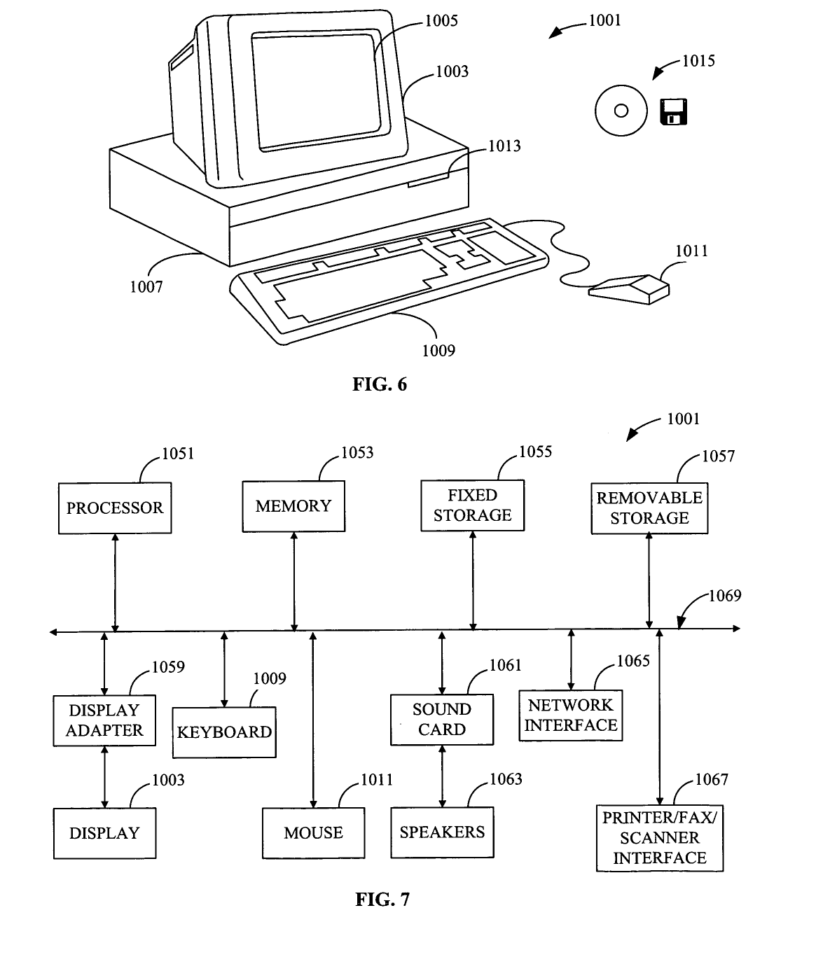

FIGS. 6 and 7 illustrate a schematic and a block diagram, respectively, of an exemplary general purpose computer system 1001 suitable for executing, for example, softphone and/or softphone-headset integrator applications described herein. The architecture and configuration of the computer system 1001 shown and described herein are merely illustrative and other computer system architectures and configurations may also be utilized.

The exemplary computer system 1001 includes a display 1003, a screen 1005, a cabinet 1007, a keyboard 1009, and a mouse 1011. The cabinet 1007 typically houses one or more drives to read a computer readable storage medium 1015, a system memory 1053, and a hard drive 1055 which can be utilized to store and/or retrieve software programs incorporating computer codes that implement the methods and processes described herein and/or data for use with the software programs, for example. A CD and a floppy disk 1015 are shown as exemplary computer readable storage media readable by a corresponding floppy disk or CD-ROM or CD-RW drive 1013. Computer readable medium typically refers to any data storage device that can store data readable by a computer system. Examples of computer readable storage media include magnetic media such as hard disks, floppy disks, and magnetic tape, optical media such as CD-ROM disks, magneto-optical media such as floptical disks, and specially configured hardware devices such as application-specific integrated circuits (ASICs), programmable logic devices (PLDs), and ROM and RAM devices.

Further, computer readable storage medium may also encompass data signals embodied in a carrier wave such as the data signals embodied in a carrier wave carried in a network. Such a network may be an intranet within a corporate or other environment, the Internet, or any network of a plurality of coupled computers such that the computer readable code may be stored and executed in a distributed fashion.

The computer system 1001 comprises various subsystems such as a microprocessor 1051 (also referred to as a CPU or central processing unit), system memory 1053, fixed storage 1055 (such as a hard drive), removable storage 1057 (such as a CD-ROM drive), display adapter 1059, sound card 1061, transducers 1063 (such as speakers and microphones), network interface 1065, and/or printer/fax/scanner interface 1067. The computer system 1001 also includes a system bus 1069. However, the specific buses shown are merely illustrative of any interconnection scheme serving to link the various subsystems. For example, a local bus can be utilized to connect the central processor to the system memory and display adapter.

Methods and processes described herein may be executed solely upon CPU 1051 and/or may be performed across a network such as the Internet, intranet networks, or LANs (local area networks) in conjunction with a remote CPU that shares a portion of the processing.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A system, comprising:
a headset base configured to communicate with a processor-based host executing a communication-headset application for interfacing between a network and the wireless headset system; and
a wireless headset in wireless communication with the headset base and configured to cooperate with the communication-headset application to answer an incoming call in response to a user call answering activity performed with and/or on the wireless headset, the wireless headset system being further configured, upon the incoming call being answered, to transmit audio signals between the network and the wireless headset via the communication-headset application being executed by the host and via the headset base.

2. The system of claim 1, wherein the user call answering activity performed with and/or on the wireless headset includes at least one of: activating or depressing a talk switch provided on the wireless headset, a voice command at the wireless headset, an activated auto answer feature, an activated voice command portal autodial feature, and removing the wireless headset from the headset base.

3. The system of claim 1, wherein the communication-headset application includes a softphone application and a softphone-headset integrator application.

4. The system of claim 1, wherein the wireless headset system is further configured to cooperate with the communication-headset application to terminate a communication call upon a user call termination activity performed with and/or on the wireless headset.

5. The system of claim 1, wherein the wireless headset system is further configured to cooperate with the communication-headset application to go off-hook for transmission of audio signals between the network and the wireless headset to facilitate placing an outgoing communication call via the communication-headset application.

6. The system of claim 1, wherein each of the headset base and the wireless headset includes a Digital Enhanced Cordless Telecommunications (DECT) controller to facilitate communication between the headset base and the wireless headset using DECT compliant technology.

7. The system of claim 1, wherein the headset base is configured to be in communication with the processor-based host via a universal serial bus (USB) port of the host.

8. The system of claim 1, wherein the communication-headset application is a Voice over Internet Protocol (VoIP) softphone-headset application.

9. The system of claim 1, wherein the communication-headset application is at least one of an intercom communication-headset application, an Internet chat-headset application, and an Internet telephony-headset application.

10. The system of claim 1, wherein the headset base is further configured to be in an incoming alert mode in response to receiving an incoming call message from the host executing the communication-headset application generated upon arrival of an incoming call via the network.

11. The system of claim 10, wherein the headset system is further configured to, when in the incoming call alert mode, at least one of: (1) emit audio sounds and/or light at the wireless headset and (2) emit audio sounds and/or light at the headset base.

12. The system of claim 1, wherein the headset system is further configured to establish an audio link between the headset base and the wireless headset upon the user call answering activity being performed.

13. The system of claim 1, wherein the headset system is further configured to transmit an acknowledge message to the host to cause the host executing the communication-headset application to answer the incoming call and to connect audio between the network and the wireless headset.

14. The system of claim 1, further comprising the processor-based host.

15. A method, comprising:
transmitting an incoming call message from a communication-headset application executing on a processor-based host upon receiving an incoming communication call on a network by the communication-headset application to a headset base of a wireless headset system;
entering an incoming call alert mode by the wireless headset system by at least one of (1) emitting audio sounds and/or light at a wireless headset of the wireless headset system, the wireless headset being in wireless communication with the headset base, and (2) emitting audio sounds and/or light at the headset base;
in response to a user call answering activity, answering the incoming call by the communication-headset application cooperating with the wireless headset system, the answering the incoming call includes establishing an audio link between the headset base and the wireless headset; and
upon the incoming call being answered, transmitting audio signals between the network and the wireless headset via the communication-headset application being executed by the host and the headset base.

16. The method of claim 15, wherein the answering the incoming call further includes:
terminating the incoming call alert mode;
transmitting a link established message to the communication-headset application; and
answering the incoming call by the communication-headset application to connect audio between the wireless headset and the network.

17. The method of claim 15, wherein the user call answering activity is selected from the group consisting of activation of a talk switch provided on the wireless headset, removal of the wireless headset from the headset base, providing a voice command at the wireless headset, activation of an auto answer feature, and activation of an answer-to-voicemail feature.

18. The method of claim 15, wherein the communication-headset application is selected from a group consisting of (1) a softphone application and a softphone-headset integrator application and (2) a single integrated softphone and softphone-headset integrator application.

19. The method of claim 15, wherein the communication-headset application is at least one of an intercom communication-headset application, an Internet chat-headset application, and an Internet telephony-headset application.

20. The method of claim 15, further comprising:
in response to a user call terminating activity, terminating a communication call by the communication-headset application cooperating with the wireless headset system.

21. The method of claim 20, wherein the user call terminating activity is selected from the group consisting of activation of the talk switch on the wireless headset and replacement of the wireless headset to the headset base.

22. The method of claim 20, wherein terminating the communication call includes:
releasing the audio link between the headset base and the wireless headset;
transmitting a call termination message from the headset base to the communication-headset application; and
terminating the communication call by the communication-headset application in response to the call termination message.

23. The method of claim 22, wherein, when the user call terminating activity is activation of the talk switch on the wireless headset, terminating the communication call further includes:
transmitting a key code corresponding to the talk switch from the wireless headset to the headset base via the audio link therebetween, wherein the transmitting the call termination message is performed upon receiving the key code corresponding to the corresponding to the talk switch at the headset base.

24. The method of claim 22, wherein when the user call terminating activity is replacement of the wireless headset to the headset base.

25. The method of claim 15, wherein each of the headset base and the wireless headset includes a Digital Enhanced Cordless Telecommunications (DECT) controller to facilitate communication between the headset base and the wireless headset using DECT compliant technology.

26. The method of claim 15, wherein the communication-headset application is a Voice over Internet Protocol (VoIP) softphone-headset application.
